(19) United States
(12) Patent Application Publication
(10) Pub. No.: US 2009/0080700 A1
(43) Pub. Date: Mar. 26, 2009

(54) PROJECTILE TRACKING SYSTEM

(76) Inventors: Daniel L. Lau, Lexington, KY (US); Michael F. Shaw, Lexington, KY (US)

Correspondence Address: STITES & HARBISON, PLLC, 400 W MARKET ST, SUITE 1800, LOUISVILLE, KY, 40202-3352, US

(21) Appl. No.: 12/146,741

(22) Filed: Jun. 26, 2008

Related U.S. Application Data
(63) Continuation of application No. 11/420,313, filed on May 25, 2006.
(60) Provisional application No. 60/684,541, filed on May 25, 2005.

(51) Int. Cl. G06K 9/00

(52) U.S. Cl. 382/103

(57) ABSTRACT

A system and method for determining the track of a projectile use a thermal signature of the projectile. Sequential infrared image frames are acquired from a sensor at a given position. A set of frames containing spots with characteristics consistent with a projectile in flight are identified. A possible projectile track solution for said spots is identified. A thermal signature value for each pixel of each spot of the possible solution is determined. The determined thermal signature is then compared to an actual thermal signature for a substantially similar projectile track to ascertain whether the determined thermal signature substantially matches the actual thermal signature, which indicates that the possible projectile track solution is the correct solution.

### CROSS-REFERENCE TO RELATED APPLICATIONS

This application claims priority to U.S. Provisional Patent Application No. 60/684,541, filed May 25, 2005, which application is hereby incorporated by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. M67854-02-D-110 awarded by the Marine Corps Systems Command.

### REFERENCE TO A “SEQUENTIAL LISTING,” A TABLE, OR A COMPUTER PROGRAM LISTING APPENDIX SUBMITTED ON A COMPACT DISC

Not applicable.

### BACKGROUND OF THE INVENTION

1. Field of the Invention

The present invention relates to infrared imaging methods and systems. More particularly, this invention relates to determining the track of a projectile using a thermal signature fingerprint of the projectile.

2. Description of Prior Art

Existing counter-sniper systems predominantly use a passive sensor, which measures naturally available energy emitted by the target, rather than an active sensor, which actively emits radiation and uses the back reflection to detect objects. The passive sensors can be further categorized as acoustic and thermal infrared as well as hybrid sensors which fuse multiple sensing mechanisms. Acoustic sensors are usually microphone arrays that triangulate their recorded signals (e.g. sound wave produced by the targeted object) to rectify the source location. The benefits of using acoustic sensors are that they provide omni-directional detection and are inexpensive to build. However, this technology is not completely appropriate for detecting subsonic projectiles or for detecting supersonic projectiles that arrive at the target prior to the arrival of the acoustical energy generated by the firing of these projectiles. Moreover, muzzle blasts are often interfered with by background noise (e.g. sea current, urban noises) and/or signals that have similar propagation speeds.

Due to the disadvantages of acoustic sensing, thermal imaging technology has become an alternative option to scientists and engineers for counter-sniper targeting systems. For thermal imaging, hot spots in the image are used to detect the muzzle flash and/or the projectiles in flight. An example of thermal imaging is infrared radiation (IR) imaging, where infrared detectors are categorized as (1) thermal detectors that sense the changes of temperature of a sensing element heated by incoming IR radiation and (2) photon detectors that convert incoming photons directly into an electrical signal.

Even though IR imaging provides images that might represent the bullet discharge (muzzle flash) as well as the projectile in flight, the existing counter-sniper targeting systems that use this technology fail in many cases to locate a sniper. This is due to the fact that these systems rely on knowing the time of firing of the bullet in order to properly model the path of the bullet.

For instance, U.S. Pat. No. 5,596,509 to Karr teaches, as shown in FIG. 1 (PRIOR ART), a passive infrared detector 10 focused on a region 12 in which a bullet 14 in flight is expected to be located. The passive infrared detector 10 is coupled to a data processor 16. The data processor 16 records successive image frames received from the detector 10. As shown in FIG. 2A and FIG. 2B, successive images are processed to almost completely cancel out background infrared radiation 18a, 18b, 18c, 18d present in the region, leaving substantially only a series of spots 20a, 20b, 20c, 20d representing a composite image of the bullet 14 over several image frames. However, the series of spots 20a, 20b, 20c, 20d alone is not adequate to represent a unique bullet track solution since multiple bullet track solutions will produce successive images having substantially similar spots.

As shown in FIG. 3, which is a overhead view of the “region” depicted in FIGS. 1, 2A and 2B, the distance between the first spot 20a and the second spot 20b represents a first angular distance θ_{ab} from the perspective of the infrared detector 10. The distance between the second spot 20b and the third spot 20c represents a second angular distance θ_{bc}, and the distance between the third spot 20c and the fourth spot 20d represents a third angular distance θ_{cd}. The angular distances θ_{ab}, θ_{bc}, θ_{cd} alone are not adequate to represent a unique bullet track solution since multiple bullet track solutions 22, 24, 26 will produce spots having substantially similar angular distances θ_{ab}, θ_{bc}, θ_{cd}. The exemplary bullet track solutions 22, 24, 26 shown represent a much larger actual set of shot origins and directions of fire with respect to the position of the infrared detector 10 that would produce a bullet track solution having spots with substantially similar angular distances θ_{ab}, θ_{bc}, θ_{cd}. Thus, without additional information, such as time of fire (or the amount of time that the bullet was in flight prior to the infrared detector 10 detecting the first spot 20a), it is not possible to determine which bullet track solution is the correct or most accurate solution.

The Karr patent suggests measuring the intensity of infrared radiation emitted from the bullet 14, and determining the path of the bullet 14 by measuring changes in the intensity of infrared radiation emitted from the bullet 14 as the bullet 14 travels through the region 12.

However, since bullets are relatively small, each pixel of the camera sensor “sees” the bullet as well as its background. Thus, the measured intensity of infrared radiation for each pixel of each bullet spot is a combination of the background radiation intensity and the bullet radiation intensity. Since the background radiation of the image can and will change from portion to portion of the image of the region, as well as from time to time depending on environmental conditions, the measured changes in intensity reflect both changes in the bullet intensity and changes in the background intensity. The Karr patent does not teach how to measure only the intensity of infrared radiation emitted from the bullet 14, as the sensor 10 measures infrared radiation that is a blended function of both the bullet 14 and the background. Because of the blended nature of the measured infrared radiation, simple frame differencing will not produce an accurate measure of the infrared radiation emitted by the bullet 14, and, therefore, cannot be used to accurately determine changes in the intensity of infrared radiation emitted from the bullet. Thus, the issue of determining the path of a bullet by measuring changes in the intensity of infrared radiation emitted from the bullet is left unresolved.

Therefore, there is a need for a system and method for determining the track of a projectile, such as a bullet, using the thermal signature of the projectile (the intensity of the infrared radiation emitted from by the projectile independent of the background radiation), which allows determining the track of the projectile without knowing the time of firing of the bullet.

### BRIEF SUMMARY OF THE INVENTION

The present invention meets the aforementioned needs, and others. Exemplary embodiments of the invention provide a system and method for tracking projectiles by their thermal signatures. As used herein, the term “projectile” shall be understood to include bullets as well as artillery shells, missiles, and other objects that exhibit the characteristics consistent with a bullet in flight. In one embodiment, a high speed infrared camera feeds images to a digital image processor and a command and control computer. Software identifies objects with characteristics consistent with a projectile in flight, and determines a projectile track solution, including the location from which the projectile was fired. Information on tracked projectiles is transmitted to other sensors or actuators by a variety of methods, including Local Area Networks (LAN's), wireless LAN's, Personal Digital Assistants (PDA's) and other similar devices. The system may be mounted on a variety of platforms, including stationary, vehicles, aerial vehicles, watercraft, etc.

Generally described, the invention allows determining the track of a projectile using a thermal signature of the projectile. A system according to the invention includes an infrared sensor, a database component, and a processing component. The infrared sensor acquires sequential infrared image frames. The database component relates projectile thermal signature values for pixel for projectile tracks detectable by the sensor. The processing component is operatively connected to the database component and the infrared sensor for: identifying a set of frames containing spots with characteristics consistent with a projectile in flight; identifying at least one possible projectile track solution for the spots; determining a projectile thermal signature value for each pixel of each spot of the possible projectile track solution; and ascertaining whether the determined projectile thermal signature substantially matches an actual projectile thermal signature from said database component for a substantially similar projectile track.

According to an aspect of the invention, the processing component comprises a projectile detection element and a track determination element. The projectile detection element identifies the frames containing spots with characteristics consistent with a projectile in flight. The track determination element identifies a possible projectile track solution, determines a projectile thermal signature value for the pixels of the spots given the possible projectile track solution, and ascertains whether the determined signature matches an actual signature from the database.

According to another aspect of the invention, identifying a set of frames containing spots with characteristics consistent with a projectile in flight includes identifying a series of spots over several frames that: are in a substantially straight line; have substantially similar spacing; and have spacing indicating a relatively fast moving object. Further, identifying a set of frames containing “projectile spots” may also include searching frames before and after the set of frames for additional spots along the substantially straight line, and including any frames containing the additional spots in the set of frames.

According to another aspect of the invention, identifying a possible projectile track solution includes: determining a centroid position of each of the spots; determining the spacing of the spot centroid positions relative to each other; and identifying at least one possible solution for a projectile track that would produce a projectile track having matching spot centroid positions.

Determining a projectile thermal signature value for each pixel of each spot of the possible solution may include: determining a measured brightness value for each pixel of each spot; determining a background brightness value for each pixel of each spot; and determining a projectile thermal signature value for each pixel of each spot by applying a predetermined blending function for each pixel of each spot of the possible projectile track solution to the measured brightness values and the average background brightness values. More specifically described, the predetermined blending function is a second-order Taylor Series expansion of the measured brightness value into intensity of the infrared radiation attributable to the projectile and the intensity of the infrared radiation attributable to the background.

According to yet another aspect of the invention, the system further has a graphical user interface component operatively connected to the processing component for presenting a final projectile track solution to a user.

The system may also have a visible light sensor positioned so as to have a field of view that overlaps a field of view of the infrared sensor. The visible light sensor would be operatively connected to the graphical user interface component, and the graphical user interface component would be further for overlaying an infrared image from the infrared sensor with a visible image from the visible light sensor for providing the user with a visible light context for the infrared image.

The system may still further have a position/direction component positioned adjacent to the infrared sensor. The position/direction component would be operatively connected to the processing component for providing the actual global position and direction of the infrared sensor to the processing component, so that the processing component can provide an actual global projectile track solution, including the actual global location of the point from which the projectile was fired.

The system may further have an active target designator unit operatively connected to the processing component for designating and tracking the projectile using the final projectile track solution.

Advantageously, the steps of the invention are efficiently and effectively performed on the processing component. Therefore, another aspect of the invention is a computer readable medium having computer executable instructions for performing a method for determining the track of a projectile using a thermal signature of the projectile, as described above.

Yet another aspect of the invention is a method for building a projectile thermal signature fingerprint record. The thermal signature fingerprint building method includes the steps of: (a) selecting an initial projectile track; (b) aiming the field of view of an infrared sensor at a portion of a path of travel of the projectile track; (c) repeatedly shooting projectiles in the projectile track in a first environmental condition; (d) recording infrared images of the projectiles of step (c); (e) repeatedly shooting projectiles in the projectile track in a second environmental condition that has a substantially different ambient temperature from the first environmental condition; (f) recording infrared images of the projectiles of step (e); (g) determining a projectile thermal signature value for each pixel corresponding to a position along the projectile track; (h) moving the infrared sensor to another portion of the path of travel of the projectile track and repeating steps (c) through (h) until the full path of travel of the projectile track is documented; and (i) selecting another projectile track and repeating steps (b) through (i) until blended function values and projectile thermal signature values are determined for observable solution tracks. The projectile thermal signature value for each pixel corresponding to a position along the projectile track is determined by: using a blending function to characterize the measured brightness value of each pixel as a blend of the infrared radiation attributable to the projectile and the infrared radiation attributable to the background; setting the average values of the radiation attributable to the projectile for each pixel of each set of images equal to one other; solving for the unknown values of the blending function for each pixel corresponding to a position along the projectile track; and solving for the projectile thermal signature value for each pixel corresponding to a position along the projectile track. Again, the blending function may be a second-order Taylor Series expansion of the measured brightness value into intensity of the infrared radiation attributable to the projectile and the intensity of the infrared radiation attributable to the background.

The preceding description is provided as a non-limiting summary of the invention only. A better understanding of the invention will be had by reference to the following detail description, and to the appended drawings and claims.

### BRIEF DESCRIPTION OF THE DRAWINGS

FIG. 1 is diagram of a prior art projectile tracking system.

FIG. 2A and FIG. 2B are diagrams of images from the prior art projectile tracking system of FIG. 1.

FIG. 3 is an overhead plan view of an infrared sensor and several possible projectile tracks that would produce an image with similar projectile spots.

FIG. 4 is a plan view of a plane defined by the location of an infrared sensor and a projectile track showing a composite thermal image of bullet spots over several image frames.

FIG. 5 is a plan view of an infrared sensor and several projectile tracks.

FIG. 6 is a diagram of projectile brightness versus distance from a sensor location.

FIG. 7 is a diagram of the position of an infrared sensor field of view for collection of data for a projectile thermal signature fingerprint record.

FIG. 8 is diagram relating a sensor angle and range in terms of d₁, d₂ and d₃.

FIG. 9 is a diagram of another position of an infrared sensor field of view for collection of data for a projectile thermal signature fingerprint record.

FIG. 10 is a diagram of discrete firing positions for several discreet d₁ values and a fixed d₂ value.

FIG. 11 is a functional block diagram of an exemplary system for determining the track of a projecting using the thermal signature of the projectile according to the invention.

FIG. 12 is a diagram of the system of FIG. 11 applied to a vehicle.

FIG. 13 is a flow chart of an exemplary method for determining the track of a projectile using the thermal signature of the projectile according to the invention.

FIG. 14 is a flow chart of the steps of a method of identifying a set of frames containing spots with characteristics consistent with a projectile in flight.

FIG. 15 is a block diagram of an exemplary sequence of filtering steps for identifying potential projectile spots.

FIG. 16 is a diagram of a combination of spots to be analyzed for determination as a projectile track.

FIG. 17A, FIG. 17B, and FIG. 17C are formulas containing criteria for classification of a set of spots as a projectile track.

FIG. 18 is a diagram of the trajectory angle and Y-intercept of an exemplary set of spots A, B, C.

FIG. 19 is a diagram showing additional spots along a best-fit line.

FIG. 20 is a detail flow chart of the steps of identifying a possible bullet track solution.

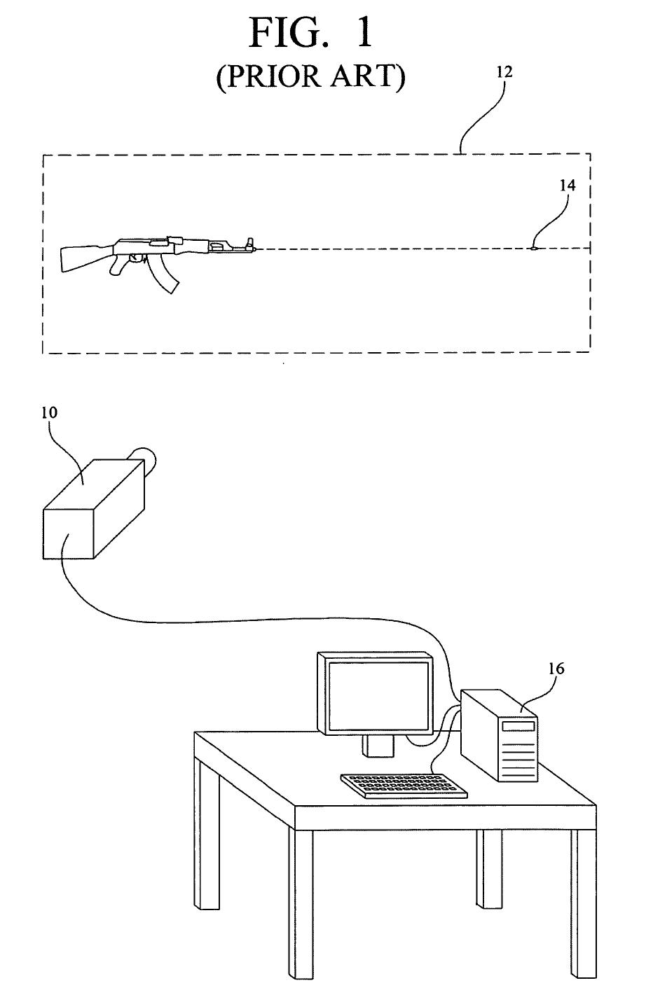

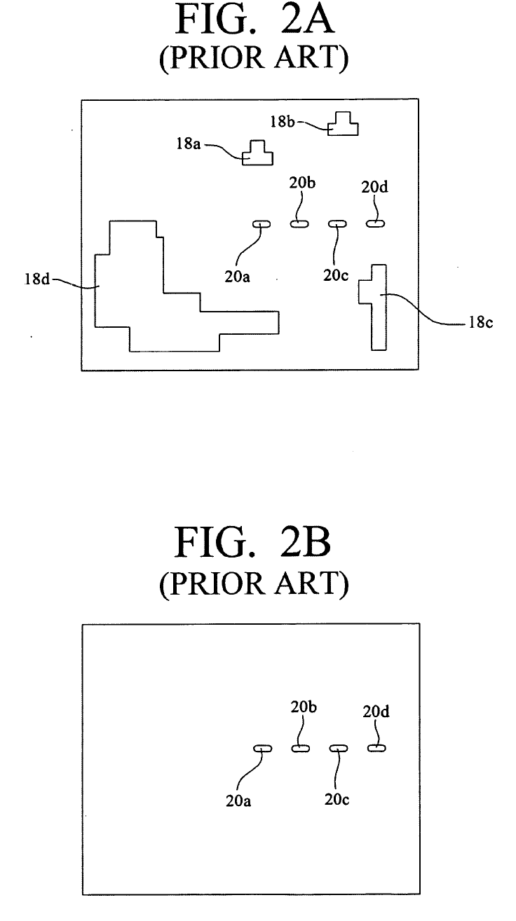

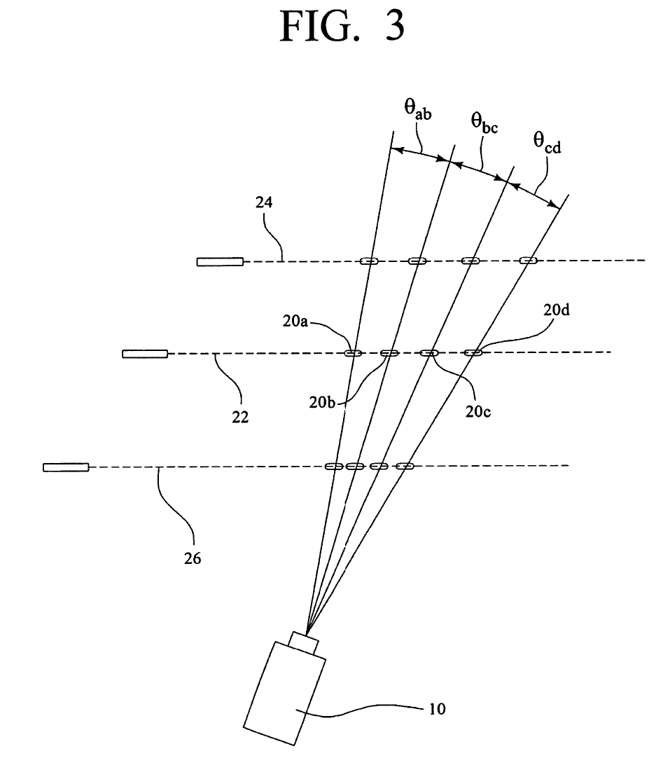

### DETAILED DESCRIPTION OF EXEMPLARY EMBODIMENTS OF THE INVENTION

### A. Every Projectile has a Unique “Thermal Signature”

FIG. 4 is a plan view of a plane defined by the location of an infrared sensor 40 and a projectile track, path, or trajectory 41. FIG. 4 shows how the composite thermal image of projectile spots over several image frames may appear with respect to the infrared sensor 40 at a given position (d₁, d₂) with respect to the location 42 from which the projectile is fired, where d is the shortest distance from the sensor 40 to the projectile path, and d₂ is the distance along the projectile path from the firing location 42 to the closest point to the sensor 40.

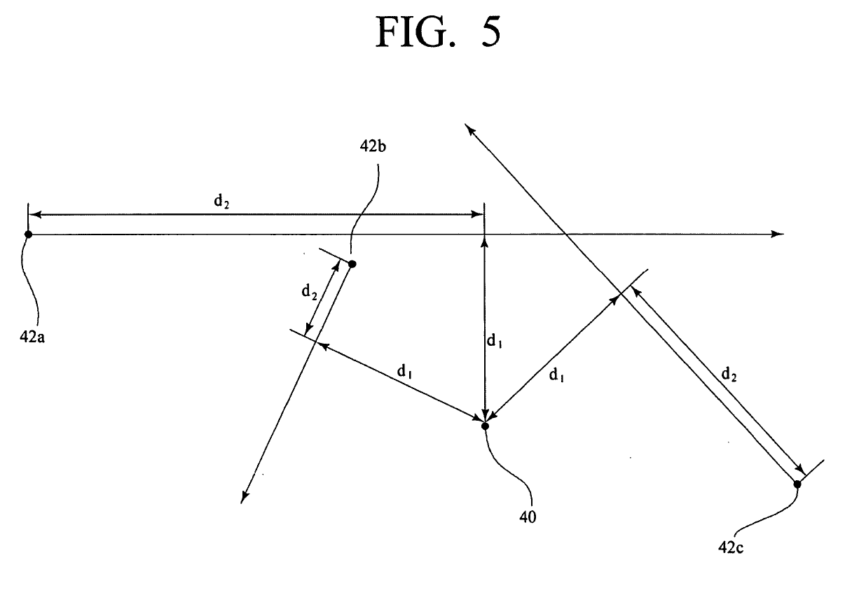

FIG. 5 shows that, assuming that a projectile's path is a straight line, any projectile path, as well as the relative locations of the infrared sensor 40 and the location 42a, 42b, 42c from which the projectile is fired can be characterized by d₁, d₂, since in geometry, a line and a point define a plane.

Returning to FIG. 4, it is shown that the projectile spots change with the range and angle of the projectile 44a, 44b relative to the sensor 40. For instance, at position A, which has a relatively large distance from the sensor 40, the sensor 40 detects a first thermal spot 46 having an area of one pixel that has a measured intensity including radiation from the projectile 44a and intensity from any background radiation 48a. Because the projectile 44a is relatively far away from the sensor 40, the physical area of the projectile 44a with respect to the area of the background 48a is relatively small and does not move much over the integration time of the image frame. Thus, the radiation from the projectile 44a is relatively opaque with respect to the radiation from the background 48a.

However, at position B, which has a relatively small distance from the sensor 40, the sensor 40 detects a thermal spot 50 having an area of two pixels as the projectile “streaks” by the location of the sensor 40 over the integration time of the image. The thermal spot 50 also has a measured intensity that includes intensity from the projectile 44b and intensity from any background radiation 48b. The physical area of the projectile 44b with respect to the area of the background 48b is relatively large and the image represents movement or “streaking” of the projectile 44b past the sensor 40 during the integration time of the image frame. Thus, the radiation from the projectile 44b is relatively transparent or blurred with respect to the radiation from the background 48b.

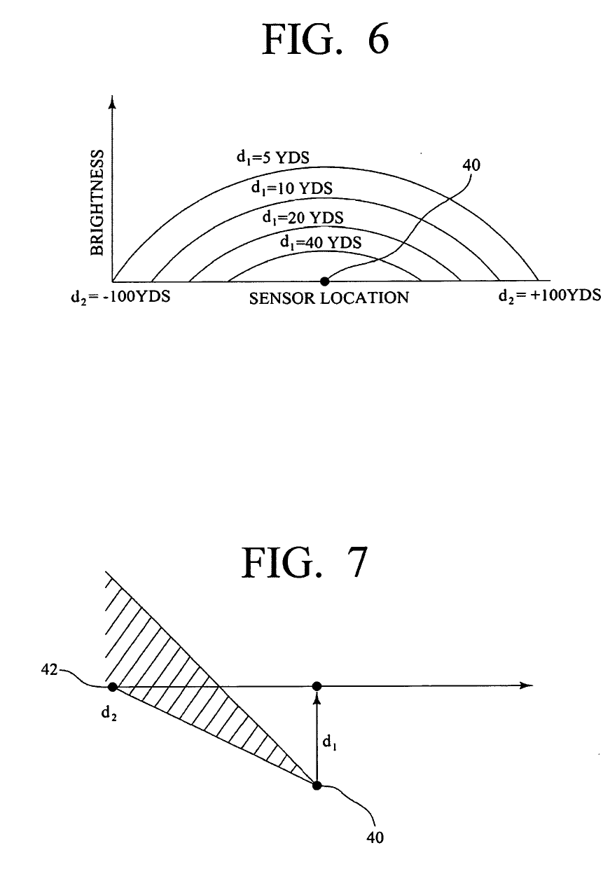

It should be noted that the sensor 40 most likely has a field of view that is much narrower than the entire region of the projectile track 41, and, most likely, has a sensitivity range and distance beyond which a projectile would be undetectable. For instance, as shown in FIG. 6, the brightness of the projectile spots decreases as d₁ and d₂ increase, reaching a combination where the brightness is undetectable by the sensor 40. Thus, in practice, the sensor 40 will likely see only a portion of the projectile track 41, as shown in FIG. 4.

However, to the extent that a projectile is detectable within the field of view of the sensor 40, the relation of the thermal characteristics of the projectile with respect to the range and angle of the projectile from the sensor 40 creates a unique “thermal signature” of the projectile. Further, projectiles of a common caliber and composition have common thermal and aerodynamic characteristics. The unique thermal signature of the projectile will be consistent for projectiles of a common caliber and composition, and substantially independent of the environmental conditions.

In one embodiment, the measured brightness of each pixel that makes up a projectile spot is written as a second-order Taylor Series expansion as follows:

MeasuredBrightnessₚᵢₓₑₗ=(alpha)ProjectileSpotBrightnessₚᵢₓₑₗ+(1−alpha)BackgroundBrightnessₚᵢₓₑₗ (1)

The alpha term has a different value for every angle and range position within the detectable region of the projectile track and ProjectileSpotBrightnessₚᵢₓₑₗ is the unique thermal signature value of the projectile at the angle and range position for the associated alpha value. One of skill in the art will recognize that higher-order expansions would produce results with greater accuracy. However, it has been determined that the second-order Taylor Series expansion provided in equation (1) will produce results with adequate accuracy.

Alpha can be derived using the following process:

As shown in FIG. 7, for a given d₁ and d₂ position, position the sensor 40 such that the left edge of the field of view is aligned with the rifle's muzzle end. Fire M shots, where M is large, recording thermal images of the resulting projectile tracks. When ambient temperatures have increased or decreased significantly, repeat the process of firing M shots and recording the thermal images of the resulting projectile tracks. For each shot, derive the best-fit line for each projectile track and then rotate the image for each shot such that the projectile trajectories of all shots are in perfect alignment with each other. Over the M shots for each batch of projectiles, each pixel of the aligned video sequences in close proximity with the aligned projectile trajectory will have some number K<M of image frames where a projectile is present. Out of the K pixels taken from the batch of M shots, calculate the average pixel intensity. Of the M−K pixels which are not projectile spots but just background, calculate the average background pixel intensity.

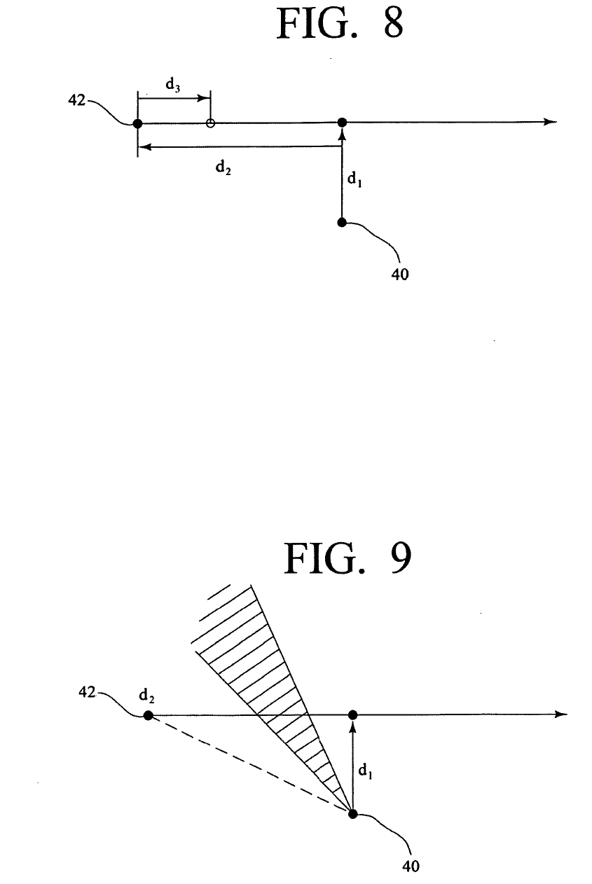

As shown in FIG. 8, the angle and range position with respect to the sensor 40 can be identified as d₁, d₂, d₃, where d₃ represents the pixel location along the projectile path image from the firing location 42.

Noting that unique thermal signature of the projectile, ProjectileSpotBrightnessₚᵢₓₑₗ, will be consistent for projectiles of a common caliber and composition at a given angle and range position with respect to the sensor 40, and substantially independent of the environmental conditions, equation (1) can be rewritten as:

(alpha)ProjectileSpotBrightnessₚᵢₓₑₗ=MeasuredBrightnessₚᵢₓₑₗ−(1−alpha)BackgroundBrightnessₚᵢₓₑₗ (2)

Setting (alpha)ProjectileSpotBrightnessₚᵢₓₑₗ equal for the pixels of images of the two batches of M shots, one can solve for alpha for each pixel location, d₃, along the projectile path image, as follows:

(MeasuredBrightnessₚᵢₓₑₗ−(1−alpha)BackgroundBrightnessₚᵢₓₑₗ)|first batch=(MeasuredBrightnessₚᵢₓₑₗ−(1−alpha)BackgroundBrightnessₚᵢₓₑₗ)|second batch (3)

Then, as shown in FIG. 9, the sensor 40 is rotated such that the left edge of the field of view is lined up with the right edge of the previous field of view. The process of firing two batches of M shots and calculating alpha versus d₃ is then repeated.

Then the process of rotating the sensor 40 such that the left edge of the field of view is lined up with the right edge of the previous field of view is continued until the entire path of the projectile from the firing location 42 until the projectile is beyond the sensor's detectable range is covered.

Once the alpha values for each pixel location, d₃, along the projectile path image are determined, the ProjectileSpotBrightnessₚᵢₓₑₗ values for each batch can be determined. The ProjectileSpotBrightnessₚᵢₓₑₗ values can then be averaged. Thus, the complete record will include the alpha values and ProjectileSpotBrightnessₚᵢₓₑₗ values for each angle and range position (measured in terms of d₁, d₂ and d₃) along the projectile path.

The process is then repeated for other possible d₁ and d₂ to build a data record of the characteristics of the projectile with respect to angle and range positions along detectable projectile tracks. To save time, only a discrete set of d₁ and d₂ values can be selected and the intermediate values interpolated. The resulting data record acts as a “thermal signature fingerprint” for projectiles having the caliber and composition of the subject projectiles.

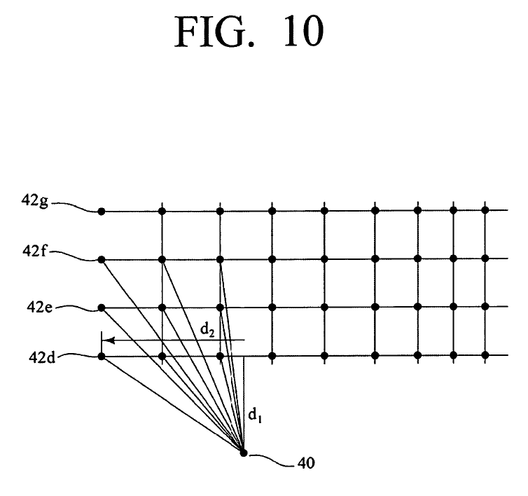

FIG. 10 shows an example of discrete firing positions 42d, 42e, 42f, 42g for several discreet d₁ values and a fixed d₂ value. With multiple shots along each track, projectile spot data should be developed for every position along each track.

Data records can then be developed for other projectile calibers and compositions, if desired, by following the same procedure.

### B. System for Determining the Track of a Projectile

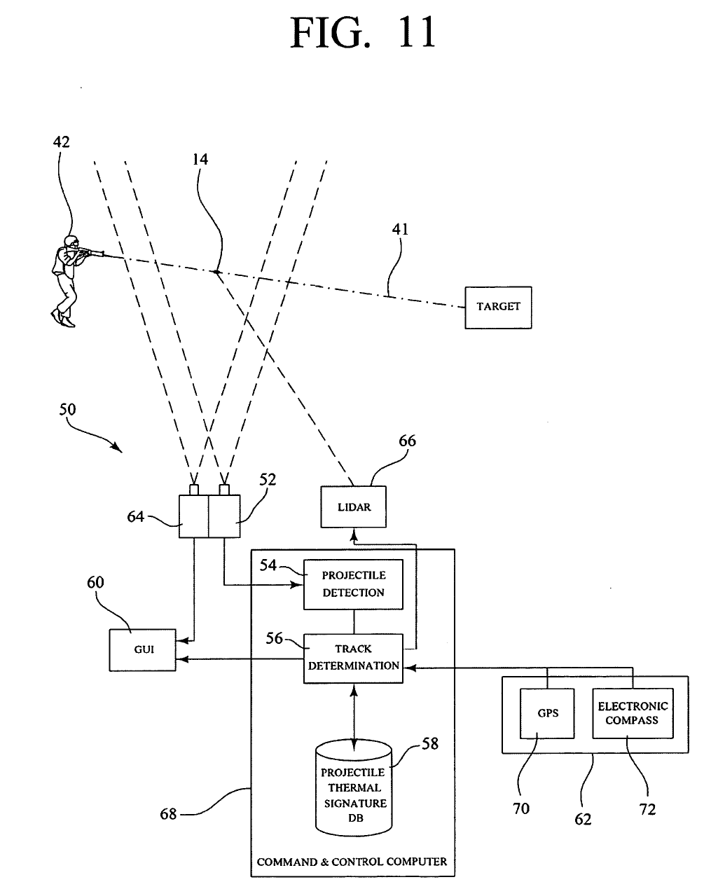

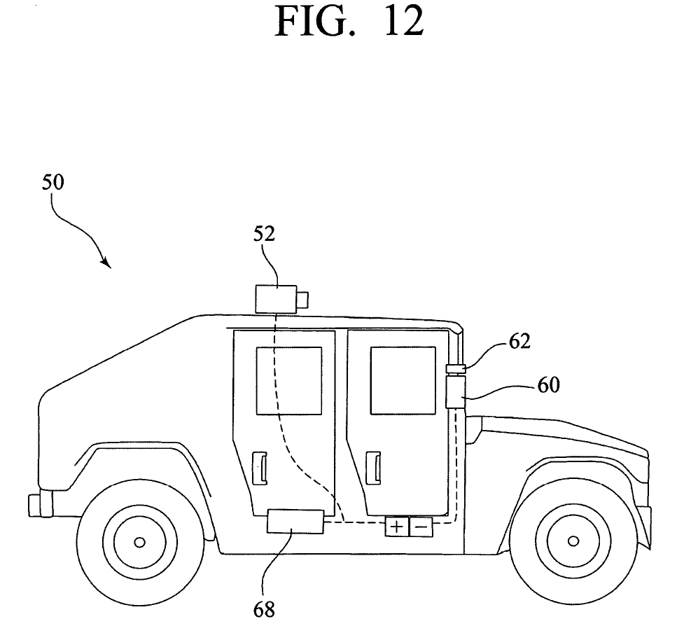

FIG. 11 is a functional block diagram of an exemplary system 50 for determining the track 41 of a projectile 14 using the thermal signature of the projectile. As shown, the exemplary system 50 includes an infrared sensor 52, a projectile detection element 54 for detecting the projectile 14, a tract determination element 56 for determining the track of the projectile 14 (including the location 42 from which the projectile 14 was fired), and a database component 58 relating projectile thermal signature values for each angle and range position with respect to the sensor location for all projectile tracks detectable by the sensor 52. Also shown are a graphical user interface (GUI) component 60, a position/direction component 62, a visible light sensor 64, and an active target designator device 66. Advantageously, the projectile detection element 54, tract determination element 56, and database component 58 may all be part of a processing component 68, such as a command and control computer, although one of skill in the art will recognize that the elements and components 54, 56, 58 may also be discreet, operatively connected components.

In one embodiment, the infrared sensor 52 is an optical, focal-plane-array detector having a 3-5 micron IR filter and working in a snap-shot style recording mode. The sensor 52 also has a high-speed video output unit, such as RS-422, camera-link, gigabit Ethernet, or similar cable interface.

The projectile detection element 54 is preferably a combination of a high-speed, digital signal processor (DSP) and software running thereon for acquiring sequential infrared images frames from a sensor at a given position, and identifying a set of frames containing spots with characteristics consistent with a projectile in flight. The projectile detection element 54 then passes the set of frames along with projectile track structure data to the tract determination element 56. The steps for identifying a set of frames containing spots with characteristics consistent with a projectile in flight will be described below.

The tract determination element 56 is preferably a combination of a computer and software running thereon for receiving the set of frames and the projectile tract structure data from the projectile detection element 54. The tract determination element 56 then: identifies at least one possible projectile track solution for the spots; determines a projectile thermal signature value for each pixel of each spot of the possible projectile track solution; retrieves actual thermal signature values for a substantially similar projectile track solution from the database component; and compares the determined thermal signature values with actual thermal signature values to determine the accuracy of the possible projectile track solution. If the accuracy is within an acceptable limit, i.e. a match, the possible projectile track solution is accepted as the actual projectile track solution. If the accuracy is not within an acceptable limit, another possible projectile track solution is identified and tested for accuracy. The steps for identifying possible projectile track solutions and determining a projectile thermal signature value for each pixel of each spot of the possible solutions will also be described below.

Once an actual projectile track solution is determined, the projectile track solution is presented to a user on the graphical user interface (GUI) component 60. The GUI 60 may be a tablet PC, a PDA, or any other interactive graphical interface. Advantageously, the visible light sensor 64, such as a video camera, can be selected and positioned so as to have a field of view that overlaps the field of view of the infrared sensor 52. In this manner, the infrared image and the visible image can be overlaid to provide the user with a visible light context for the infrared images.

Further, while the actual projectile track solution will provide the location 42 from which the projectile was fired as well as the projectile track 41 with respect to the location of the infrared sensor 52, the position/direction component 62 will provide the actual position and direction of the infrared sensor 52. This will allow global identification of the location 42 from which the projectile was fired and the projectile track 41, rather than just identification of the parameters with respect to the location of the infrared sensor 52. As shown, the position/direction component 62 may include a global positioning system (GPS) unit 70 and an electronic compass unit 72.

Further, the actual projectile track solution may be output to an active target designator unit 66, such as a Light Detection and Ranging (LIDAR) device, for designating and tracking the projectile.

FIG. 12 shows application of the system 50 to a vehicle, including the infrared sensor 52, processing component 68, graphical user interface (GUI) component 60, and position/direction component 62. Advantageously, the system 50 can be ruggedized and operated: as a stationary system for surveillance of urban areas, sporting venues, battlefields, etc.; or as a mobile system on vehicles, aircraft, watercraft, or even integrated into a soldier's helmet or incorporated as a viewing system (scope) on top of a soldier's weapon.

### C. Method for Determining the Track of a Projectile

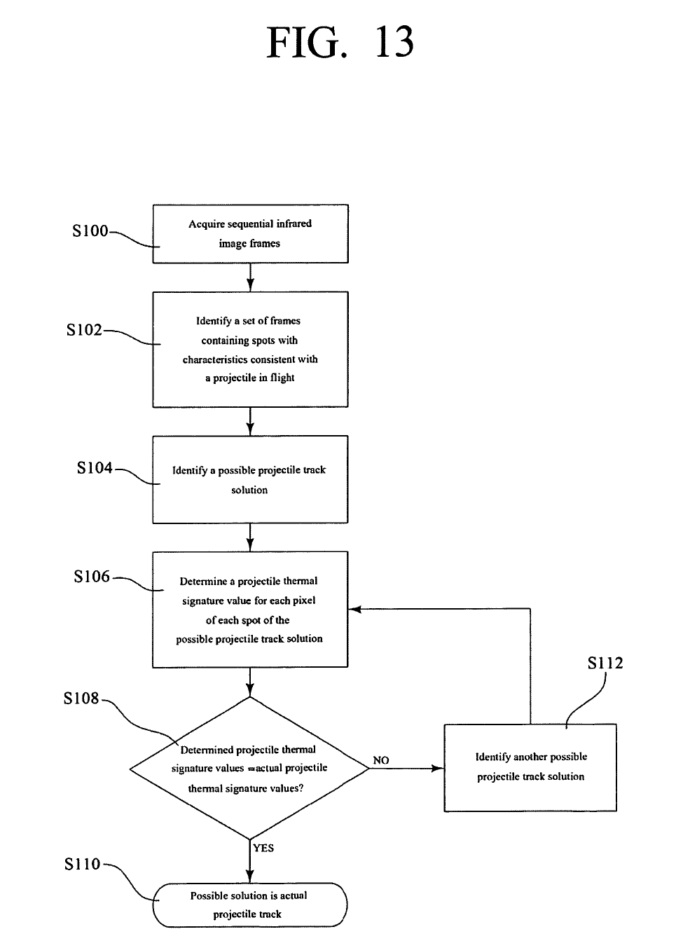

FIG. 13 is a flow chart of an exemplary method for determining the track of a projectile using a thermal signature fingerprint of the projectile. The exemplary method of FIG. 13 includes the steps of: S100 acquiring sequential infrared image frames from a sensor at a given position; S102 identifying a set of frames containing spots with characteristics consistent with a projectile in flight; S104 identifying at least one possible projectile track solution for said spots; S106 determining a projectile thermal signature value for each pixel of each spot of the possible projectile track solution; S108 comparing said determined projectile thermal signature values for the possible projectile track solution with actual projectile thermal signature values for a substantially similar projectile track solution to ascertain whether the determined thermal signature substantially matches the actual thermal signature; S110 if the possible projectile track solution matches, then the possible solution is determined to be the actual solution; and S112 if the possible projectile track solution is not accurate, then identifying another possible projectile track solution and returning to step S106.

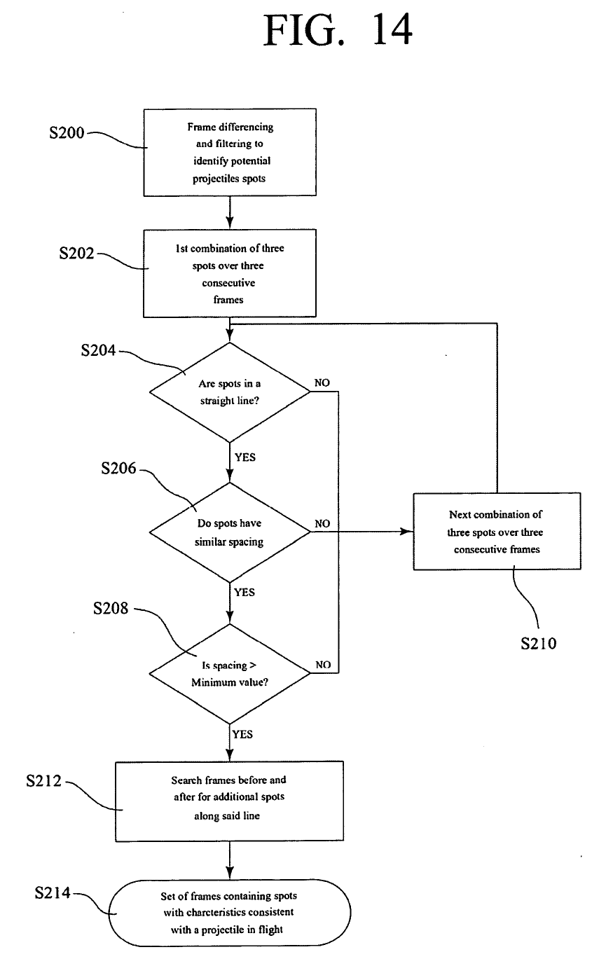

The step of identifying a set of frames containing spots with characteristics consistent with a projectile in flight is shown in more detail in FIG. 14. As a first step S200, frame differencing and filtering is performed on the sequential infrared image frames to identify potential projectile spots.

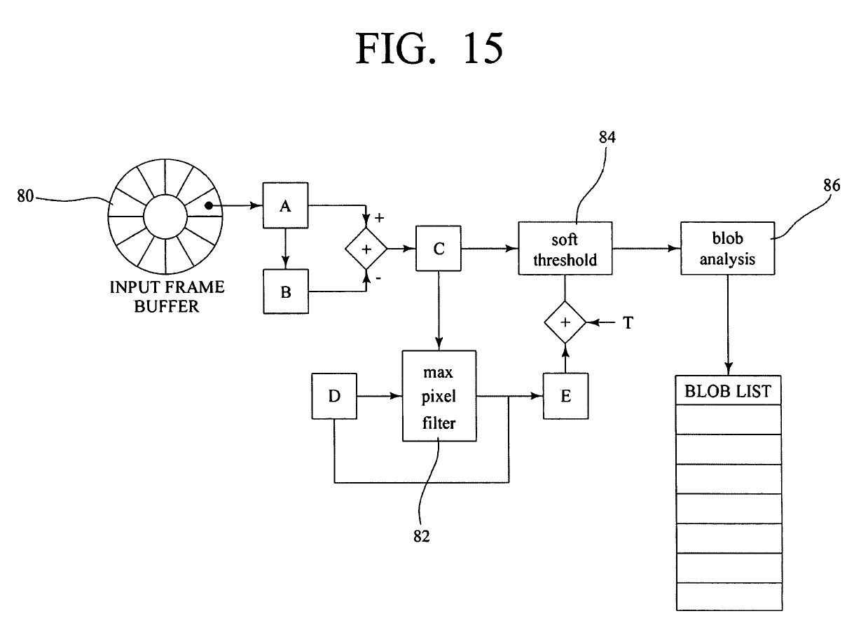

FIG. 15 is a block diagram of an exemplary sequence of differencing and filtering steps for identifying potential projectile spots (or blobs). As shown, sequential thermal image video frames are input to a circular buffer 80. Consecutive frames A, B are then subtracted to yield a difference image C that contains only pixels with different values from the consecutive frames A, B. The difference image is then filtered to remove noise, such as by using a Max Pixel Filter 82 and a Soft Threshold Filter 84. The Max Pixel Filter 82 will examine every pixel of a previous set of difference images C (such as 200 images) to create an image E that contains pixels of the maximum value in the set. The image E is also stored as a reference image D, which is reset every second or so. A constant T is added to the maximum pixel image E, and this image is used for the Soft Threshold Filter 84 to allow only pixels with a significant difference, such as would be characteristic of a projectile thermal spot, to proceed to a Blob Analysis Process 86.

Alternatively, the filtering steps could include the following steps: A mean, variance, and standard deviation of the previous twenty difference video frames are calculated recursively. As a new frame is captured, the oldest frame is removed from the mean and the new frame is added. The new mean is calculated without having to use the entire 20 frames. The most recent difference frame is threshold pixelwise using the standard deviation. Any pixel value below a multiple of the standard deviation is set to zero. In this way, projectiles whose pixel values exceed the background standard deviation will be detected, but Gaussian noise which will only rarely exceed a value of three times the standard deviation will be filtered out. The threshold image is segmented into blobs to isolate the projectile data. The resulting threshold difference video will still contain some high frequency noise along with the projectile data. Noise data generally has a small blob size and can be eliminated by excluding blobs having an area less than a certain limit.

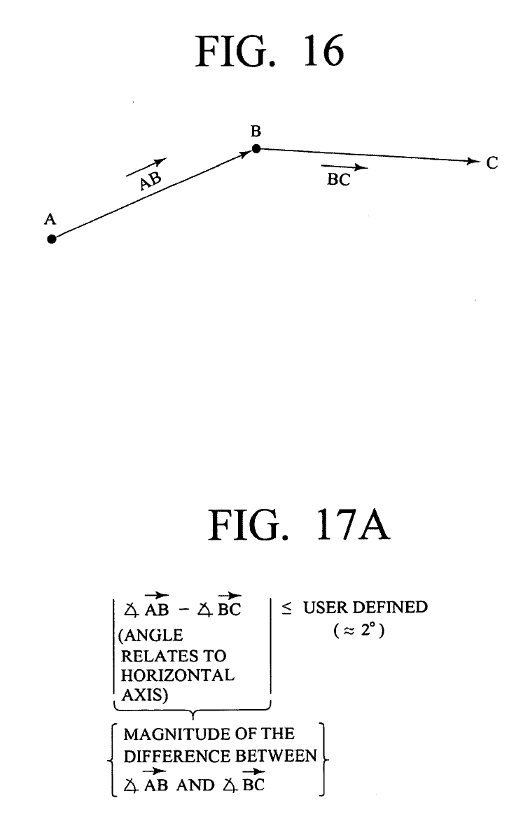

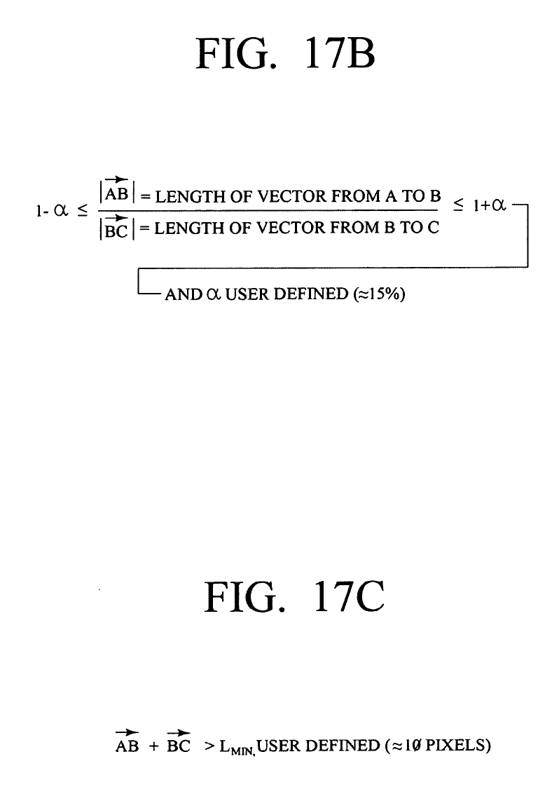

Once potential projectile spots are identified following the filtering process, the potential projectile spots are analyzed to determine if they have characteristics of a projectile in flight. To be classified as a projectile spot, all combinations of three spots over three consecutive frames (one spot for each frame) are examined. The centroids of spots comprising more than one pixel may be determined for the purpose of analyzing the spots. FIG. 16 shows a particular combination of spots A, B, C, where C is from the most recent frame, B is from the previous frame, and A is from two frames back, AB is the vector from A to B, and BC is the vector from B to C. Assuming that a projectile travels along a straight-line path and that the ratio of the spacing from A to B versus from B to C should be close to one, spots A, B and C are classified as a projectile if the criteria shown in FIG. 17A, FIG. 17B, and FIG. 17C are met.

Returning to FIG. 14, the steps of analyzing potential projectile spots to determine if they have the characteristics of a projectile in flight are shown as the following steps: S202 obtaining a first combination of three spots over three consecutive frames; S204 determining if the spots are in a straight line; S206 determining if the spots have similar spacing; and S208 determining if the spacing is greater than a minimum value (to indicate that the potential projectile is a relatively fast moving object).

If any of the determinations S204, S206, S208 is negative, then the spots do not have the characteristics of a projectile in flight, and the next step would be S210 obtaining the next combination of three spots over the three consecutive frames. The next combination of three spots would then be analyzed for the necessary criteria in steps S204, S206 and S208.

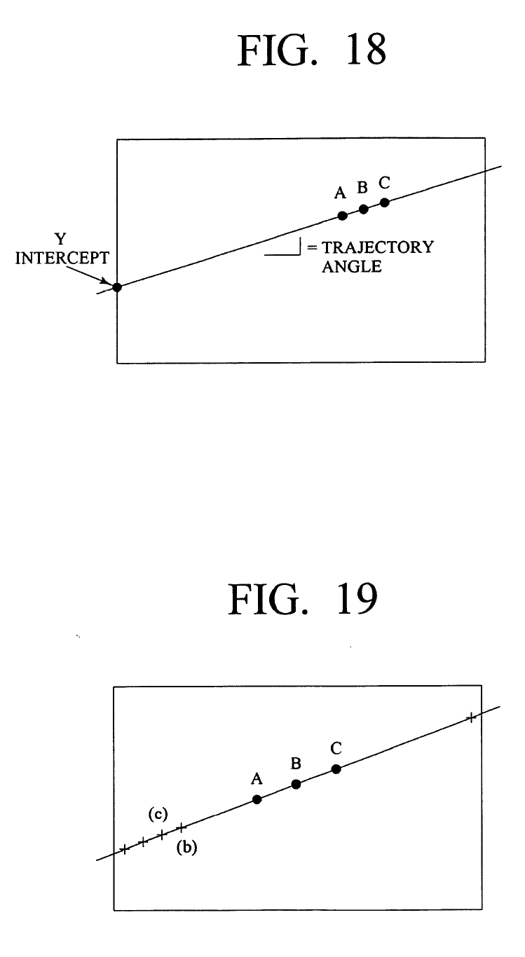

However, if the determinations S204, S206, S208 are affirmative, then the spots are classified as a projectile track, and a new projectile track structure record is created. The projectile track structure includes data such as: the frame numbers of the frames containing the spots, centroids of the spots, the trajectory angle between the best fit straight line connecting A, B, C and the horizontal axis, and the Y-intercept of the same best fit line. FIG. 18 shows the trajectory angle and Y-intercept of an exemplary set of spots A, B, C.

The steps S200, S202, S204, S206, S208 and S210 must be performed in real-time, meaning that the projectile detection element 54 (FIG. 11) must be capable of processing the data for each frame before the next frame of video is captured. Current technology DSP components are capable of processing video images having a size of 320×128 pixels at 200 frames per second, but it is anticipated that future technology components will be capable of processing higher resolution or larger images at faster rates for use with infrared sensors with higher frame capture rates and higher image resolutions. Further, it is contemplated that a second DSP component could be utilized in conjunction with a first DSP component, such that the first component could be dedicated to frame buffering, while the second DSP component could perform the filtering and analysis steps on a sub-group of frames (such as every other frame) to accomplish the function of projectile detection. One of skill in the art will recognize that the spirit and scope of the invention described and claimed herein is independent of such specifications and not limited thereby.

Assuming that A is not the first appearance of the projectile, then there exist a projectile track structure generated during the previous frames. As such prior to creating a new projectile track, the list of all tracks available from the previous frame is searched such that, if the trajectory angle and Y-intercept of the best fit line to A, B and C is equal or close to the angle and intercept of an existing track, then the projectile track structure data is updated with the new data for C.

The next frame may or may not contain an additional spot to add to the projectile track structure. If it does not contain an additional spot to add, then the projectile track structure may be classified as expired, and ready to be post processed.

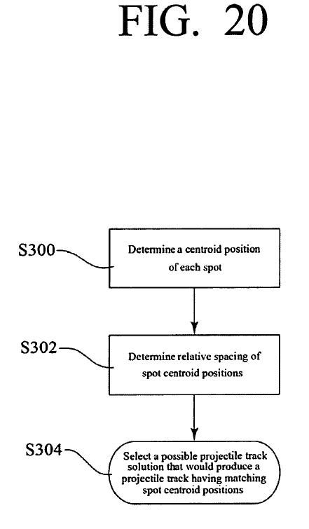

Post processing includes searching frames before and after the frames containing the spots in the projectile track structure for additional spots along the best-fit line and at increments of the anticipated spacing, such as shown in FIG. 19. Post processing begins by calculating an average ratio of the distances between two consecutive spots such that, for only three spots, A, B, and C, the average distance ratio is:

$$AverageDistanceRatio = \frac{BC}{AB} \qquad ( 4 )$$

For four consecutive spots, A, B, C, and D, the average distance ratio is:

$$AverageDistanceRatio = \frac{1}{2} [ \frac{B C}{A B} + \frac{C D}{B C} ] \qquad ( 5 )$$

Given the average distance ratio, AverageDistanceRatio, the number of frames prior to a projectile's first sighting as well as after its last sighting when it may not have been detecting because of adaptive thresholding or because its path may have been obscured from view can be determined. With continued reference to FIG. 19, to get the number of frames prior to A, step a distance (|AB|/AverageDistanceRatio) from A and away from B along the track's best-fit straight line. If this spot is within the field of view of the camera, then the number of previous frames that the projectile may be visible is at least 1.

Defining this new point as b, then travel a distance (|bA|/AverageDistanceRatio) from b and away from A to get point c, and so on until the number of steps needed to move outside the camera's field of view is found. This number, minus 1, is the number of frames prior to A that the projectile might be visible, although not detected.

For getting the number of frames after C, a distance (|BC|* AverageDistanceRatio) from C and away from B, must be moved along the best-fit line. Repeating this process, the number of frames after C that the projectile may be visible can be estimated.

In order to complete the post processing of an expired projectile track, all video frames from the circular input frame buffer corresponding to the detected spots in the track, as well as all frames where the spot may have been visible prior to A and all frames where the spot may have been visible after the last spot C are extracted. These extracted video frames along with the projectile track structure record are then moved off the projectile detection element 54 (FIG. 11) and down to the tract determination element 56 (FIG. 11) in order to further exploit the projectile's thermal signature and to identify the location from which the projectile was fired.

Thus, returning to FIG. 14, post processing is reflected as steps: S212, search frames before and after for additional spots along the straight line and at increments for additional spots; and S214, extract set of frames containing spots with characteristics consistent with a projectile in flight.

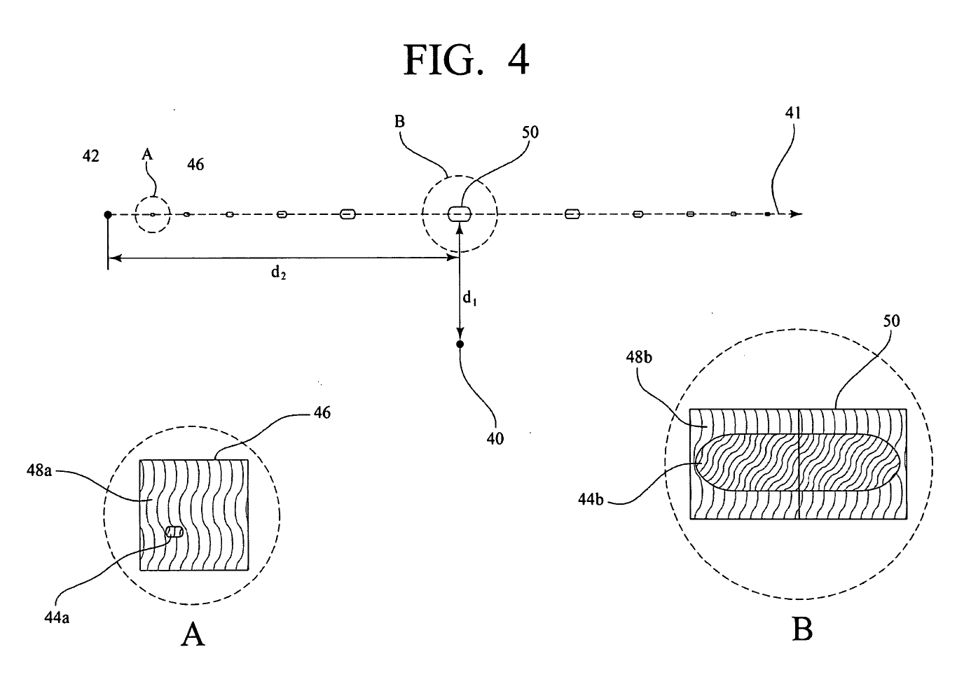

Turning now to determining the track of the projectile, including the location from which the projectile was fired, FIG. 20 is a flow chart of the detail of the step of S104 identifying a possible projectile track solution (FIG. 13). Identifying a possible projectile track solution includes the steps of: S300 determining a centroid position of each spot in set of frames containing spots with characteristics consistent with a projectile in flight; and S302 determining the relative spacing of the spot centroid positions. As discussed earlier in reference to FIG. 3, the relative spacing of the spot centroid positions represents angular distances from the perspective of the infrared detector. There will be multiple possible projectile track solutions that produce spots having centroid positions with similar relative spacing (or angular distances). The possible projectile track solutions can be determined theoretically or experimentally. Since experimental data has already been collected for development of the data record for the projectile “thermal signature fingerprint” described earlier, such data can also be utilized for identifying possible projectile track solutions that would produce a projectile track with matching spot centroids. Thus, the data from the experimental shots taken in developing the projectile “thermal signature fingerprint” data record can be utilized to determine d₁, d₂ values that produce projectile tracks having projectile tracks having matching spot centroid positions. The next step, S304, is therefore selecting one of the possible projectile track solutions.

Returning now to FIG. 13, once the possible projectile track solution is selected, the determined alpha values for the possible solution from the projectile “thermal signature fingerprint” record can be used for the step S106 of determining the ProjectileSpotBrightnessₚᵢₓₑₗ (projectile thermal signature) values for the pixels of each spot according to:

$${ProjectileSpotBrightness}_{pixel} = \frac{\begin{matrix}{MeasuredBrightness}_{pixel} - \\ ( 1 - alpha ) {BackgroundBrightness}_{pixel}\end{matrix}}{alpha} \qquad ( 6 )$$

MeasuredBrightnessₚᵢₓₑₗ and BackgroundBrightnessₚᵢₓₑₗ are obtained from the actual spots from the set of frames, as described for obtaining these values for the projectile “thermal signature fingerprint” record.

After determining the ProjectileSpotBrightnessₚᵢₓₑₗ (projectile thermal signature) values for the pixels of each spot, these values can be compared to the actual values from the projectile “thermal signature fingerprint” record. The final projectile track solution is the one that minimizes the mean square error, over all of the pixels, of ProjectileSpotBrightnessₚᵢₓₑₗ (projectile thermal signature) values for the pixels of each spot from the possible projectile track solutions.

### D. Potential Applications

Advantageously, the system and methods disclosed herein are applicable to detecting and tracking projectiles, and have potential applications well beyond “sniper” detection. For instance, the thermal signature fingerprint of a projectile may be used to evaluate projectiles larger than bullets for verifying or creating ballistics range tables for creation of Surface Danger Zone templates, for gathering ballistic firing table data, and for gathering terminal ballistics data against specific targets. Other potential uses include: munitions arena testing, projectile flight characteristics development, terminal ballistics lethality data collection, operational suitability analysis, verifying lethality models in support of future combat system programs, and for safety and operational suitability testing.

Additional potential applications of the system and methods disclosed herein include: law enforcement (routine, special events (e.g. large spectator events), surveillance of high crime rate areas, convoy security for VIPs/diplomats); homeland security (border patrolling); airport security; government office security (embassy surveillance); and military applications (projectiles and munitions, stealth craft, aircraft and watercraft detection through clouds and fog, perimeter security, convoy security, Military Operations on Urban Terrain (MOUT) operations and environment, and counter-sniper/counter battery fires).

Thus, the improvements described herein provide a method and system for determining the track of a projectile using a thermal signature of the projectile. One of ordinary skill in the art will recognize that additional configurations are possible without departing from the teachings of the invention or the scope of the claims which follow. This detailed description, and particularly the specific details of the exemplary embodiments disclosed, is given primarily for completeness and no unnecessary limitations are to be imputed therefrom, for modifications will become obvious to those skilled in the art upon reading this disclosure and may be made without departing from the spirit or scope of the claimed invention.

What is claimed is:

1. A method for determining the track of a projectile using a thermal signature of the projectile, said method comprising the steps of:
acquiring sequential infrared image frames from a sensor at a given position;
identifying a set of frames containing spots with characteristics consistent with a projectile in flight;
identifying at least one possible projectile track solution for said spots;
determining a projectile thermal signature value for each pixel of each spot of the possible projectile track solution;
ascertaining whether said determined projectile thermal signature substantially matches an actual projectile thermal signature for a substantially similar projectile track.

2. The method of claim 1, wherein said step of identifying a set of frames containing spots with characteristics consistent with a projectile in flight includes identifying a series of spots over several frames that:
are in a substantially straight line;
have substantially similar spacing; and
have spacing indicating a relatively fast moving object.

3. The method of claim 2, further comprising searching frames before and after said set of frames for additional spots along said substantially straight line, and including any frames containing said additional spots in said set of frames.

4. The method of claim 1, wherein said step of identifying at least one possible projectile track solution includes:
determining a centroid position of each of said spots;
determining the spacing of said spot centroid positions relative to each other; and
identifying at least one possible projectile track solution that would produce a projectile track having matching spot centroid positions.

5. The method of claim 1, wherein said step of determining a projectile thermal signature value for each pixel of each spot of the possible projectile track solution includes:
determining a measured brightness value for each pixel of each spot;
determining a background brightness value for each pixel of each spot; and
determining a projectile thermal signature value for each pixel of each spot by applying a predetermined blending function for each pixel of each spot of the possible projectile track solution to said measured brightness values and said background brightness values.

6. The method of claim 5, wherein said step of determining a background brightness value for each pixel of each spot includes averaging the brightness values of the pixels that correspond to the pixels of each spot in the set of frames that do not contain the respective spots.

7. The method of claim 5, wherein said predetermined blending function is a second-order Taylor Series expansion of the measured brightness value into intensity of the infrared radiation attributable to the projectile and the intensity of the infrared radiation attributable to the background.

8. A system for determining the track of a projectile using a thermal signature of the projectile, said system comprising:
an infrared sensor for acquiring sequential infrared image frames;
a database component relating projectile thermal signature values for each pixel of each spot for projectile tracks detectable by said infrared sensor; and
a processing component, operatively connected to said database component and said infrared sensor, for:
identifying a set of frames containing spots with characteristics consistent with a projectile in flight;
identifying at least one possible projectile track solution for said spots;
determining a projectile thermal signature value for each pixel of each spot of the possible projectile track solution; and
ascertaining whether said determined projectile thermal signature substantially matches an actual projectile thermal signature from said database component for a substantially similar projectile track.

9. The system of claim 8, wherein said processing component comprises a projectile detection element and a track determination element, said projectile detection element for identifying said set of frames containing spots with characteristics consistent with a projectile in flight, and said track determination element for:
identifying at least one possible projectile track solution for said spots;
determining a projectile thermal signature value for each pixel of each spot of the possible projectile track solution; and
ascertaining whether said determined projectile thermal signature substantially matches an actual projectile thermal signature from said database component for a substantially similar projectile track.

10. The system of claim 8, wherein said processing component is further for identifying a series of spots over several frames that:
are in a substantially straight line;
have substantially similar spacing; and
have spacing indicating a relatively fast moving object.

11. The system of claim 10, wherein said processing component is further for searching frames before and after said set of frames for additional spots along said substantially straight line, and including any frames containing said additional spots in said set of frames.

12. The system of claim 8, wherein said processing component is further for:
determining a centroid position of each of said spots;
determining the spacing of said spot centroid positions relative to each other;
identifying at least one possible projectile track solution that would produce a projectile track having matching spot centroid positions.

13. The system of claim 8, wherein said processing component is further for:
determining a measured brightness value for each pixel of each spot;
determining a background brightness value for each pixel of each spot; and
determining a projectile thermal signature value for each pixel of each spot by applying a predetermined blending function for each pixel of each spot of the possible projectile track solution to said measured brightness values and said background brightness values.

14. The system of claim 13, wherein said predetermined blending function is a second-order Taylor Series expansion of the measured brightness value into intensity of the infrared radiation attributable to the projectile and the intensity of the infrared radiation attributable to the background.

15. The system of claim 8, further comprising a graphical user interface component operatively connected to said processing component for presenting a final projectile track solution to a user.

16. The system of claim 15, further comprising a visible light sensor positioned so as to have a field of view that overlaps a field of view of said infrared sensor, said visible light sensor operatively connected to said graphical user interface component, said graphical user interface component further for overlaying an infrared image from said infrared sensor with a visible image from said visible light sensor for providing said user with a visible light context for said infrared image.

17. The system of claim 8, further comprising a position/direction component proximate said infrared sensor, said position/direction component operatively connected to said processing component for providing an actual global position and direction of said infrared sensor to said processing component, said processing component further for providing an actual global projectile track solution, including the actual global location from which the projectile was fired.

18. The system of claim 8, further comprising an active target designator unit operatively connected to said processing component for designating and tracking the projectile using a final projectile track solution.

19. A computer readable medium having computer executable instructions for performing a method for determining the track of a projectile using a thermal signature of the projectile, said method comprising the steps of:
acquiring sequential infrared image frames from a sensor at a given position;
identifying a set of frames containing spots with characteristics consistent with a projectile in flight;
identifying at least one possible projectile track solution for said spots;
determining a projectile thermal signature value for each pixel of each spot of the possible projectile track solution;
ascertaining whether said determined projectile thermal signature substantially matches an actual projectile thermal signature for a substantially similar projectile track.

20. The computer readable medium of claim 19, wherein said computer executable instructions for performing said step of identifying a set of frames containing spots with characteristics consistent with a projectile in flight includes computer executable instructions for identifying a series of spots over several frames that:
are in a substantially straight line;
have substantially similar spacing; and
have spacing indicating a relatively fast moving object.

21. The computer readable medium of claim 20, further having computer executable instructions for searching frames before and after said set of frames for additional spots along said substantially straight line, and including any frames containing said additional spots in said set of frames.

22. The computer readable medium of claim 19, wherein said computer executable instructions for performing said step of identifying at least one possible projectile track solution include computer executable instructions for:
determining a centroid position of each of said spots;
determining the spacing of said spot centroid positions relative to each other; and
identifying at least one possible projectile track solution that would produce a projectile track having matching spot centroid positions.

23. The computer readable medium of claim 19, wherein said computer executable instructions for performing said step of determining a projectile thermal signature value for each pixel of each spot of the possible projectile track solution include computer executable instructions for:
determining a measured brightness value for each pixel of each spot;
determining a background brightness value for each pixel of each spot; and
determining a projectile thermal signature value for each pixel of each spot by applying a predetermined blending function for each pixel of each spot of the possible projectile track solution to said measured brightness values and said background brightness values.

24. The computer readable medium of claim 23, wherein said computer executable instructions for applying a blending function include computer executable instructions for applying a second-order Taylor Series expansion of the measured brightness value into intensity of the infrared radiation attributable to the projectile and the intensity of the infrared radiation attributable to the background.

25. A method of building a projectile thermal signature record comprising the steps of:
(a) selecting an initial projectile track;
(b) aiming the field of view of an infrared sensor at a portion of a path of travel of said projectile track;
(c) repeatedly shooting projectiles in said projectile track in a first environmental condition;
(d) recording infrared images of said projectiles of step (c);
(e) repeatedly shooting projectiles in said projectile track in a second environmental condition that has a substantially different ambient temperature from said first environmental condition;
(f) recording infrared images of said projectiles of step (e);
(g) determining a projectile thermal signature value for each pixel corresponding to a position along said projectile track by:
using a blending function to characterize the measured brightness value of each pixel as a blend of the infrared radiation attributable to the projectile and the infrared radiation attributable to the background;
setting the average values of the radiation attributable to the projectile for each pixel of each set of images equal to one other;
solving for the unknown values of the blending function for each pixel corresponding to a position along said projectile track; and
solving for the projectile thermal signature value for each pixel corresponding to a position along said projectile track;
(h) moving said infrared sensor to another portion of said path of travel of said projectile track and repeating steps (c) through (h) until the full path of travel of said projectile track is documented; and
(i) selecting another projectile track and repeating steps (b) through (i) until blended function values and projectile thermal signature values are determined for observable solution tracks.

26. The method of claim 25, wherein said blending function is a second-order Taylor Series expansion of the measured brightness value into intensity of the infrared radiation attributable to the projectile and the intensity of the infrared radiation attributable to the background
